(19) United States
(12) Patent Application Publication
(10) Pub. No.: US 2016/0103576 A1
(43) Pub. Date: Apr. 14, 2016

(54) NAVIGATING APPLICATION INTERFACE

(71) Applicant: Alibaba Group Holding Limited, Grand Cayman (KY)

(72) Inventor: Lei Zhang, Hangzhou (CN)

(21) Appl. No.: 14/871,486

(22) Filed: Sep. 30, 2015

(30) Foreign Application Priority Data
Oct. 9, 2014 (CN) 201410528700.8

(51) Int. Cl. G06F 3/0484; G06F 3/0481

(52) U.S. Cl. CPC G06F 3/0484; G06F 3/0481

(57) ABSTRACT

When detecting a preset trigger event, the techniques of the present disclosure determine a current application interface on a terminal screen and display interface navigation information corresponding to an application to which the current application interface belongs, in which the interface navigation information includes a plurality of display elements in a hierarchical structure, and the hierarchical structure corresponds to a hierarchical relationship among a plurality of application interfaces of the application. Through the technical solution of the present disclosure, it is easy for users to figure out the hierarchical relationship among the application interfaces of the application, and to complete the operation navigation of the application interfaces.

### CROSS-REFERENCE TO RELATED PATENT APPLICATION

This application claims foreign priority to Chinese Patent Application No. 201410528700.8 filed on 9 Oct. 2014, entitled “Method and Apparatus for Navigating Application Interface,” which is hereby incorporated by reference in its entirety.

### TECHNICAL FIELD

The present disclosure relates to the technical field of terminals, and, more particularly to a method and apparatus for navigating an application interface.

### BACKGROUND

With the rapid progress of technology, applications are implementing more and more functions. In order to distinguish different application functions and data reasonably, under restrictions of sizes of terminal screens, the applications request a plurality of application interfaces to present various application functions, data, and so on.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method and apparatus for navigating an application interface, which enable users to conveniently find a hierarchical relationship among application interfaces of applications and implement operation navigation for the application interfaces.

In order to achieve the above objectives, the present disclosure provides the following technical solutions.

The present disclosure provides an example method for navigating an application interface, which may include the following operations:

when detecting a preset trigger event, determining a current application interface on a terminal screen; and

displaying interface navigation information corresponding to an application to which the current application interface belongs, in which the interface navigation information includes a plurality of display elements in a hierarchical structure, and the hierarchical structure corresponds to a hierarchical relationship among a plurality of application interfaces of the application.

The present disclosure provides an apparatus for navigating an application interface, which may include the following units:

a determining unit that determines a current application interface on a terminal screen when detecting a preset trigger event; and

a displaying unit that displays interface navigation information corresponding to an application to which the current application interface belongs, in which the interface navigation information includes a plurality of display elements in a hierarchical structure, and the hierarchical structure corresponds to a hierarchical relationship among a plurality of application interfaces of the application.

As shown from the above technical solutions, by generating interface navigation information corresponding to a hierarchical relationship among the application interfaces, the present disclosure enables users to find a structural relationship among the application interfaces of the current application conveniently and quickly locate and search application interfaces, thereby enhancing operation efficiency of the application.

### BRIEF DESCRIPTION OF THE DRAWINGS

FIGS. 1(A)-1(F) are schematic views of example of switching among application interfaces in a plurality of hierarchical levels.

FIG. 2 is a flow chart of an example method for navigating application interface according to the present disclosure.

FIG. 3 is a flow chart of another example method for navigating application interface according to the present disclosure.

FIG. 4 is a schematic view of example interface navigation information according to the present disclosure.

FIG. 5 is a flow chart of another example method for navigating application interface according to the present disclosure.

FIG. 6 is a schematic view of another example interface navigation information according to the present disclosure.

FIG. 7 is a structural schematic view of an example electronic device according to the present disclosure.

FIG. 8 is a block diagram of an example apparatus for navigating application interface according to the present disclosure.

### DETAILED DESCRIPTION

In order to reasonably distinguish application functions, data, and so on, an application usually has a plurality of application interfaces. These application interfaces may have a complicated hierarchical structural relation among one another. As a result, when a user uses the application, the user may get “lost.” that is, the user cannot ascertain how to enter an exact application interface with desired functions.

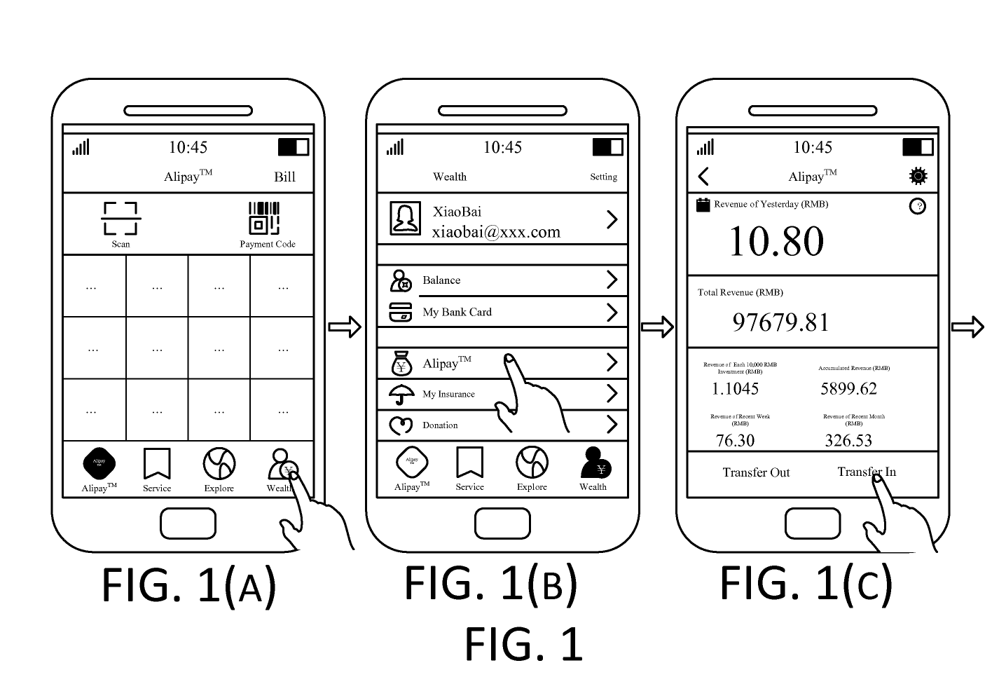

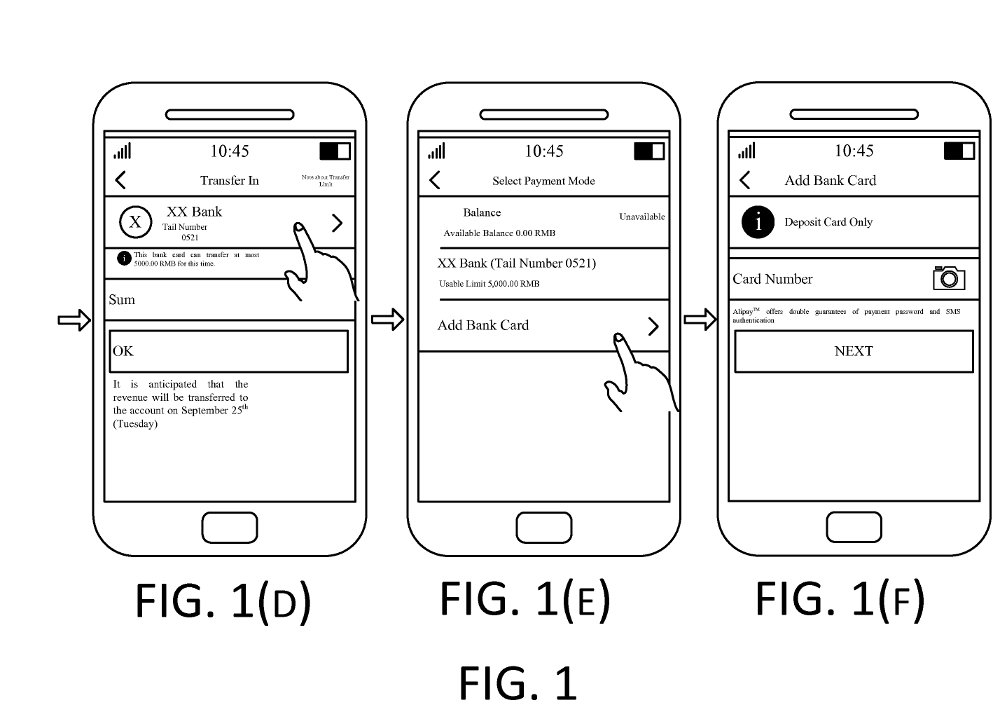

For example, FIGS. 1(A)-(F) show schematic views of example switching among application interfaces in a plurality of hierarchical levels in a cell phone client terminal of “Alipay™”. FIG. 1(a) is an application interface of an application such as an online financing application “Alipay™”, which is the upmost application interface of this application. When a user wants to deposit money to a fund account such as “Yu'ebao” by using a new bank card, the user needs to complete this function through the following operations:

In the application interface named “Alipay™” shown in FIG. 1(a), selecting “Wealth”, and jumping to an application interface named “Wealth” as shown in FIG. 1(b); in the application interface named “Wealth” as shown in FIG. 1(b), selecting “Yu'ebao”, and jumping to an application interface named “Yu'ebao” as shown in FIG. 1(c); in the application interface named “Yu'ebao” as shown in FIG. 1(c), selecting “Transfer In”, and jumping to an application interface named “Transfer In” as shown in FIG. 1(d); in the application interface named “Transfer In” as shown in FIG. 1(d), selecting “XX Bank”, and jumping to an application interface named “Select Payment Option” as shown in FIG. 1(e); in the application interface named “Select Payment Option” as shown in FIG. 1(e), selecting “Add Bank Card”, and jumping to an application interface named “Add Bank Card” as shown in FIG. 1(f).

In the above operations, the user finally completes adding a new bank card and transferring the deposit by jumping five times among the above 6 application interfaces. The operations are complicated. Moreover, if the user temporarily wants to return to a certain application interface or turn to another new application interface during the above operation process, it is possible that the user does not know how to switch among the application interfaces.

In response to the above situation, the present disclosure generates interface navigation information corresponding to a hierarchical relationship among the application interfaces, so that the user conveniently figures out a structural relationship among the application interfaces in the current application, and quickly locates and searches the application interfaces, thereby enhancing an operation efficiency of the applications.

In order to further demonstrate the present disclosure, the present disclosure provides the following example embodiments.

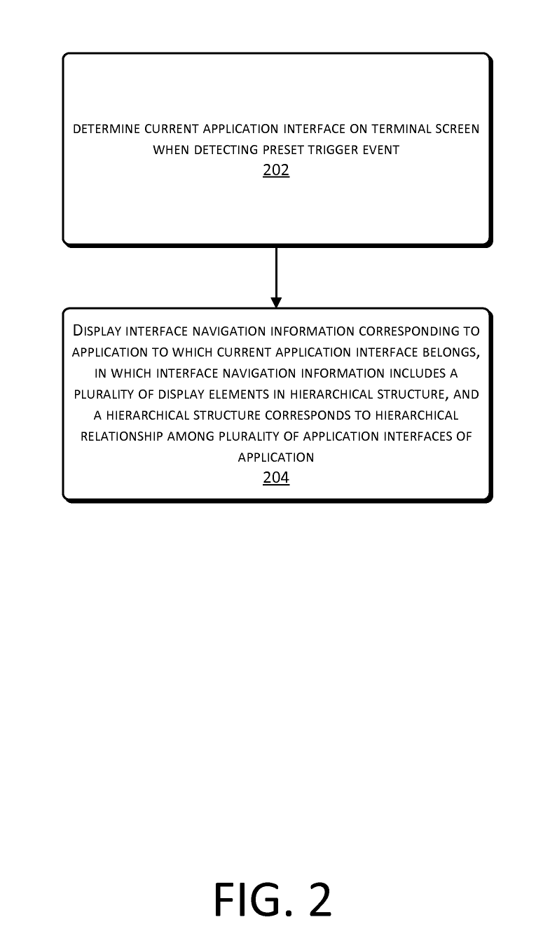

Referring to FIG. 2, FIG. 2 is a flow chart of an example method for navigating an application interface according to an example embodiment of the present disclosure. This method may be applied at a terminal, and may include the following operations:

At 202, when a preset trigger event is detected, a current application interface on a terminal screen is determined.

In this example embodiment, the preset trigger event may be a user's operation in any form. For example, when detecting that a user presses a certain physical key or a combination of a plurality of physical keys, when detecting that a user clicks a certain virtual function control on a terminal screen, or when detecting that a terminal is shaken or swayed by a user (e.g., an operation named “Shake”), and so on, preset trigger events are considered detected. In addition, the preset trigger event may be user-defined depending upon actual requirements.

At 204, interface navigation information corresponding to an application to which the current application interface belongs is displayed. The interface navigation information includes a plurality of display elements in a hierarchical structure, and the hierarchical structure corresponds to a hierarchical relationship among a plurality of application interfaces of the application.

In this example embodiment, as an illustration, the display elements included in the interface navigation information may only correspond to a part of application interfaces in the application, for example, a hierarchical relationship among application interfaces already being operated by the user (e.g., application interfaces from FIG. 1(a) to FIG. 1(f)), which is easy for the user to perform an operation of “Return.” For another example, the display elements included in the interface navigation information may correspond to application interfaces having a hierarchical relationship with the current application interface in the application, and such application interfaces are usually of the same “branch” that is used for completing the same or similar functions, so that the user may complete navigation among the application interfaces of the same branch. For another example, the display elements included in the interface navigation information may correspond to all application interfaces in the application, so that the user views not only a hierarchical relationship among the application interface already operated, and easily perform the operation of “Return” and so on, but also hierarchical level information of all the other application functions, and thus the user easily figures out all application functions in the application, and accesses all the application interfaces as well.

In this example embodiment, the interface navigation information may be pre-generated. Thus, when a preset trigger event is detected, the interface navigation information is called and displayed on the terminal screen. Alternatively, the interface navigation information may be generated in real time, for example, based on the user's browsing records, so that the display elements in the interface navigation information merely correspond to the user's browsing records.

As known from the above technical solutions, the present disclosure generates interface navigation information corresponding to a hierarchical relationship among the application interfaces, so that the user conveniently figures out a structural relation among the application interfaces in the current application, and quickly locates and searches the application interfaces, thereby enhancing an operation efficiency of the applications.

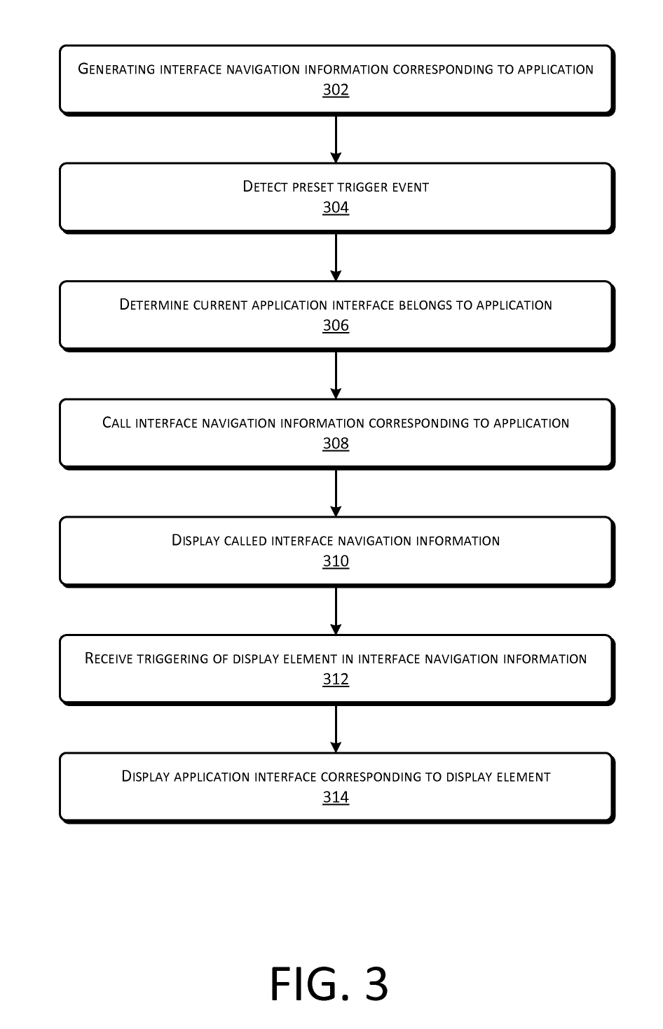

Referring to FIG. 3, FIG. 3 is a flow chart of another example method for navigating application interface according to another example embodiment of the present disclosure, which may include the following operations:

At 302, interface navigation information corresponding to an application is generated.

In this example embodiment, by using the pre-generated the interface navigation information, when a terminal needs to display the interface navigation information, the pre-stored interface navigation information is called, which is helpful for preventing the user from waiting for a long time during the process of generating the interface navigation information in real time.

For example, the interface navigation information may be generated by a server, and the interface navigation information is added to an installation file of the application. Alternatively, a request is independently initiated to the server, to obtain interface navigation information matched with the application, and the interface navigation information is pre-stored in the terminal.

At 304, a preset trigger event is detected.

In this example embodiment, the preset trigger event may be set according to actual requirements. For example, when detecting that the user performs the operation of “Shake” on the terminal, the techniques of the present disclosure determines that a preset trigger event is detected.

At 306, an application to which the current application interface belongs is determined. For example, the application is determined as an application A.

At 308, interface navigation information corresponding to the application A, i.e., the interface navigation information pre-stored in the terminal, is called.

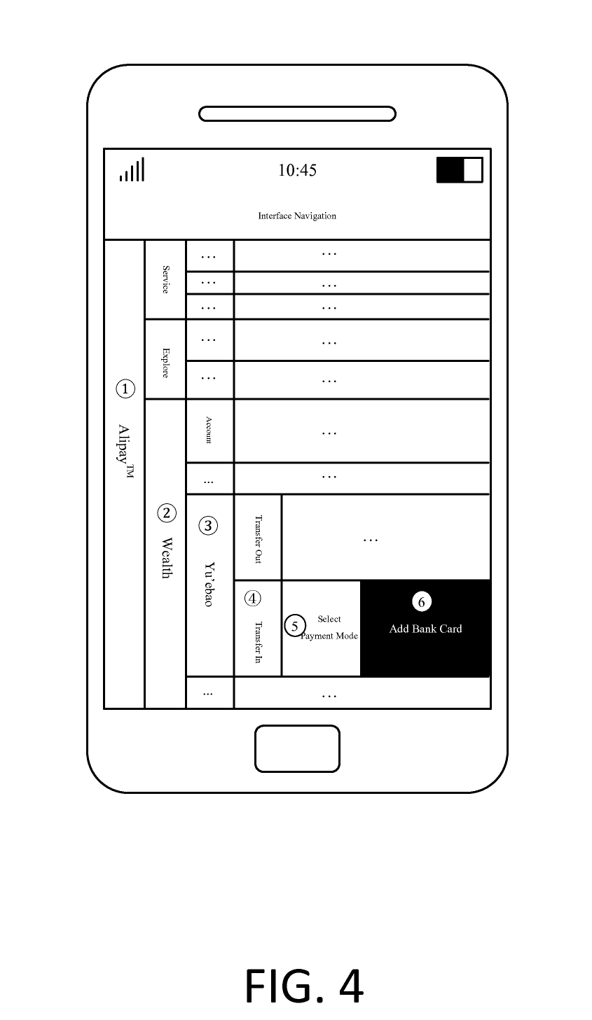

When the application A is “Alipay™”, the corresponding interface navigation information is shown in FIG. 4, which may include display elements such as “Alipay™”, “Service”, “Explore”, corresponding to the respective application interfaces. As an example embodiment, in the interface navigation information as shown in FIG. 4, the display elements correspond to all application interfaces in “Alipay™”, and the hierarchical structure (e.g., a corresponding hierarchical structure presented in a form of table as shown in FIG. 4) among these display elements reflects a hierarchical relationship among the application interfaces.

As an example embodiment, when the display elements in the interface navigation information correspond to all application interfaces in the application A, browsing information of the application interfaces for current-time operation of the application A is recorded. (“Current-time operation” is understood as starting from a time point when the application A is started most recently to a time point when the application A is terminated most recently; and the application A being “terminated” is understood as leaving all application interfaces of the application A, or shutting down a process corresponding to the application A.) The browsing information in the interface navigation information is highlighted.

For example, as shown in FIG. 4, when the user performs a browsing operation as shown in FIG. 1, the display elements corresponding to application interfaces such as “Alipay™”, “Wealth”, “Yu'ebao”, “Transfer In”, “Select Payment Option”, “Add Bank Card” and so on are highlighted when being displayed. The “highlighting” form adopted in FIG. 4 may include adding serial numbers to the corresponding display elements. On one hand, these display elements are distinguished from other display elements (e.g., “Service”, “Explore”, “Transfer Out”, and so on) corresponding to those application interfaces that are not browsed yet; on the other hand, a browsing sequence for the user to browse the application interfaces corresponding to the display elements is marked, which shows that the user's browsing sequence is: \textcircled{1}“Alipay™”→\textcircled{2}“Wealth”→\textcircled{3}“Yu' ebao”→\textcircled{4}“Transfer In”→\textcircled{5}“Select Payment Option”→\textcircled{6}“Add Bank Card”. Furthermore, the display element corresponding to the current application interface (that is, the last browsed application interface before the user calls the interface navigation information, e.g., the display element \textcircled{6} marked in FIG. 4) may be processed in terms of the displaying effects, so that it is different from all the other display elements, which is convenient for the user to locate his/her browsing position, and is helpful for the user to complete interface navigation in a better way. For example, in FIG. 4, the display element \textcircled{6} is displayed as “white characters on black background”, whereas the other display elements are all displayed as “black characters on white background”.

At 310, the called interface navigation information is displayed on a terminal screen.

At 312, a triggering of a display element, such as the display element as shown in FIG. 4, in the interface navigation information is received.

In this example embodiment, with respect to the display elements in the interface navigation information as shown in FIG. 4, the user not only directly observes contents and structural relations among the display elements, but also, through the created links between these display elements and the corresponding application interfaces, quickly visits the application interfaces by triggering these corresponding display elements.

For example, assuming that the display element \textcircled{3} is triggered, that is, the user selects (e.g., directly clicks by using a finger) the display element “Yu'ebao”, so that a user interface directly jumps to the corresponding application interface of “Yu'ebao” as shown in FIG. 1(c).

At 314, an application interface corresponding to the triggered display element, such as the display element \textcircled{3} is displayed or the user interface is jumped to such application interface corresponding to the triggered display element.

In this example embodiment, in addition to the display elements corresponding to the application interfaces that have already been browsed such as the display element \textcircled{3}, the user may select any display element in the navigation interface information as shown in FIG. 4, and thus quickly visits the corresponding application interface, thereby avoiding switching and jumping repeatedly among different hierarchical levels, and enhancing the operation and browsing efficiency.

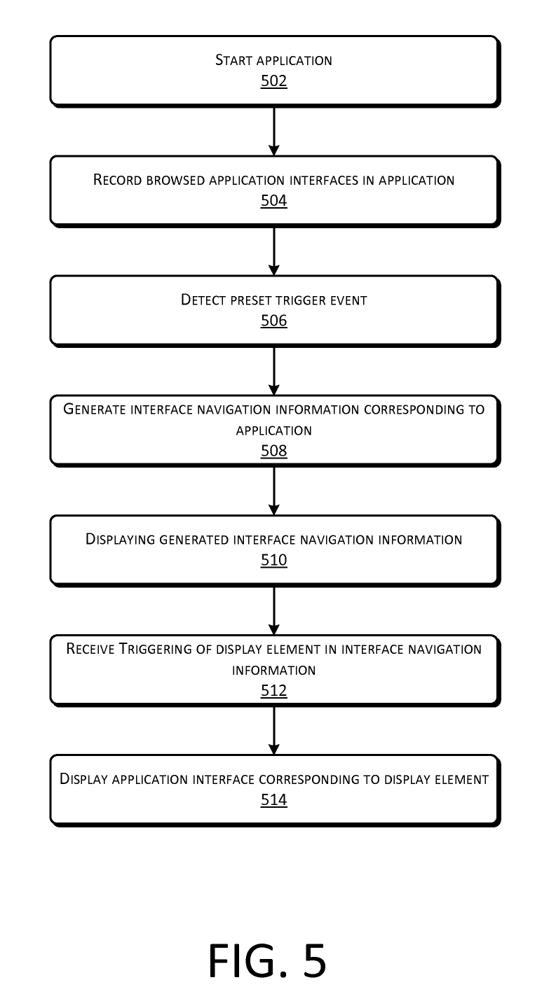

Referring to FIG. 5, FIG. 5 is a flow chart of another example method for navigating application interface according to another example embodiment of the present disclosure, which may include the following operations:

At 502, an application such as application A is started or actuated.

In this example embodiment, the user may directly actuate the application A by clicking an application icon or pressing a physical key on a terminal, or the user may indirectly actuate the application A by function calling in another application B.

At 504, application interfaces browsed in the application are recorded before the application A is terminated by the user.

At 506, a preset trigger event is detected.

At 508, interface navigation information corresponding to the application is generated.

In this example embodiment, the corresponding interface navigation information is generated based on the browsing information of a user, so that it is easy for the user to switch and jump among the browsed application interfaces.

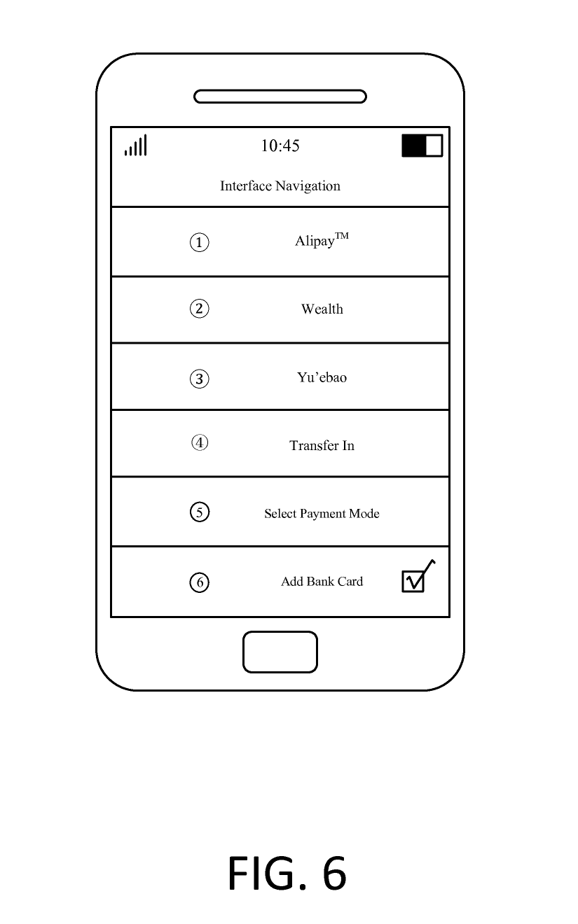

For example, the user's browsing information is shown in FIG. 1, that is, the user sequentially browses the application interfaces of “Alipay™”, “Wealth”, “Yu'ebao”, “Transfer In”, “Select Payment Option”, “Add Bank Card”, and so on, so that the interface navigation information as shown in FIG. 6 is generated, which includes display elements corresponding to the application interfaces already browsed by the user, and these display elements are arranged based on a hierarchical relationship among the application interfaces.

Optionally, based on a browsing sequence of the user that browses the application interfaces corresponding to the display elements, a serial number as shown in FIG. 6 may be added to the corresponding display element, for example, a serial number \textcircled{1} is correspondingly added to “Alipay™”, a serial number \textcircled{2} is correspondingly added to “Wealth” and so forth, which indicates that the user's browsing sequence is that: \textcircled{1}“Alipay™”→\textcircled{2}“Wealth”→\textcircled{3}“Yu'ebao”→\textcircled{4}“Transfer In”→\textcircled{5}“Select Payment Option”→\textcircled{6}“Add Bank Card”. Furthermore, the display element corresponding to the current application interface (that is, the last browsed application interface before the user calls the interface navigation information, for example, the display element \textcircled{6} as shown in FIG. 6) may be processed in terms of the displaying effects, so that it is different from all the other display elements. Thus, it is easy for the user to locate his/her browsing position, and helpful for the user to complete interface navigation in a better way. For example, as shown in FIG. 6, only the display element \textcircled{6} has a corresponding identifier of “√”.

In this example embodiment, the user may browse the application interfaces such as “Alipay™”, “Wealth”, “Yu'ebao”, “Transfer In”, “Select Payment Option”, “Add Bank Card”, and so on as shown FIG. 1, but may also further browse the application interfaces such as “Explore”, which covers a “branch 1”: “Alipay™”→“Wealth”→“Yu'ebao”→“Transfer In”→“Select Payment Option”→“Add Bank Card”, and further covers a “branch 2”: “Alipay™”→“Explore” . . . Thus, when the user browses the application interfaces this time, the browsed application interfaces may have a plurality of “branches”.

As an example embodiment, among all the browsed application interfaces, application interfaces having a hierarchical relationship with the current application interface are determined, and then interface navigation information is generated based on the determined application interfaces. For example, the current application interface is “Add Bank Card”, only the interface navigation information generated by the “branch 1” is displayed on a terminal screen, and the display elements corresponding to the application interfaces in the “branch 2” and the other branches are omitted. For another example, interface navigation information may be generated based on application interfaces in all branches.

At 510, the generated interface navigation information is displayed.

At 512, a triggering of a display element such as a display element \textcircled{3} in the interface navigation information is received.

In this example embodiment, with respect to the display elements in the interface navigation information as shown in FIG. 4, the user not only directly observes contents and structural relations among these display elements, but also, through created links between these display elements and the corresponding application interfaces, quickly visits the application interfaces by triggering the corresponding display elements.

For example, assuming that the display element \textcircled{3} is triggered, that is, the user selects (e.g., directly clicks by using a finger) the display element “Yu'ebao”, so that the user interface directly jumps to the corresponding application interface of “Yu'ebao” as shown in FIG. 1(c).

At 514, an application interface corresponding to the triggered display element, such as the display element \textcircled{3} is displayed or the user interface is jumped to such application interface corresponding to the triggered display element.

It should be noted that, the processing flow shown in FIG. 3 calls the pre-stored interface navigation information, and then displays the interface navigation information. Correspondingly, as shown in FIG. 4, the display elements in the interface navigation information correspond to all application interfaces in the application. The processing flow shown in FIG. 5 generates the interface navigation information in real time, and then displays the interface navigation information. Correspondingly, as shown in FIG. 6, the display elements in the interface navigation information correspond to the application interfaces already browsed by the user, instead of all the application interfaces in the application. However, depending upon actual requirements, when the interface navigation information is pre-stored and called, the display elements in the corresponding interface navigation information may correspond to a part of the application interfaces as well, for example, the application interfaces already browsed by the user. Similarly, when the interface navigation information is generated in real time, the display elements in the corresponding interface navigation information may correspond to all application interfaces in the application as well.

In addition to the methods for navigating the application interfaces as shown in FIG. 3 and FIG. 5, the technical solution of the present disclosure also has many other embodiments. For example, as an example embodiment, based on a current application interface where the user triggers the interface navigation information, application interfaces having a hierarchical relationship with the current application interface in the corresponding application are determined, and then interface navigation information is generated based on the determined application interfaces. For example, as shown in FIG. 6, application interfaces corresponding to 6 display elements have a hierarchical relationship: “Alipay™”→“Wealth”→“Yu'ebao”→“Transfer In”→“Select Payment Option”→“Add Bank Card”. Thus, when the user calls the interface navigation information on any interface among the 6 application interfaces, the interface navigation information as shown in FIG. 6 is called.

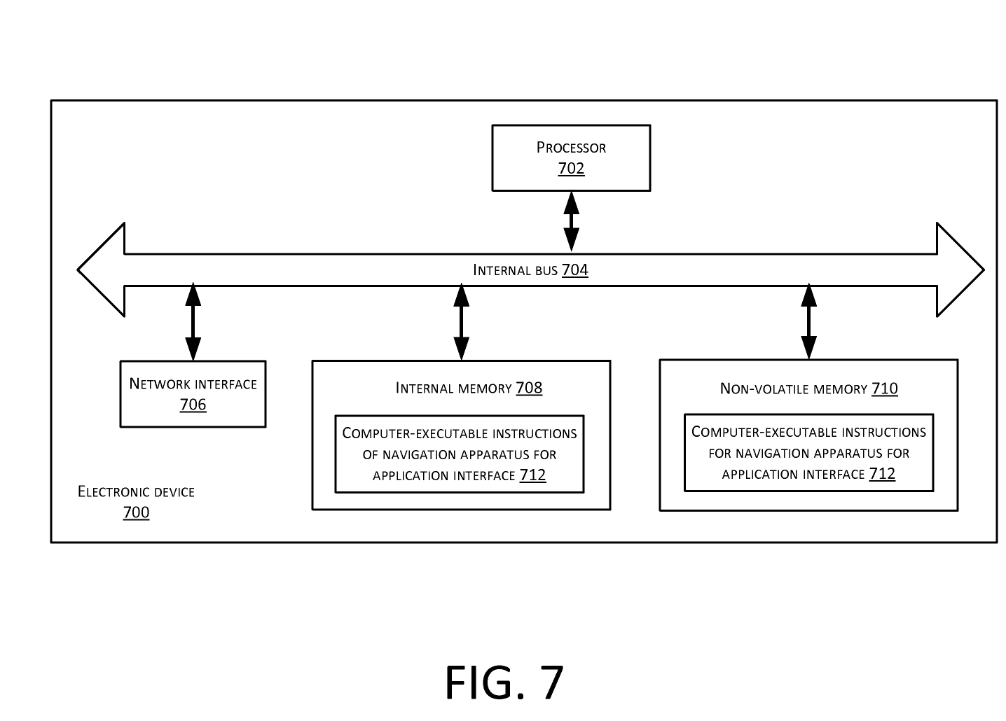

FIG. 7 is a structural schematic view of an example electronic device 700 according to an example embodiment of the present disclosure. Referring to FIG. 7, in terms of hardware, the electronic device 700 includes one or more processor(s) 702 or data processing unit(s), internal bus(es) 704, network interface(s) 706, internal memory 708, non-volatile memory 710, and other hardware requested by other services. The processor(s) 702 read corresponding computer-executable instructions of a navigation apparatus for application interfaces 712 from the non-volatile memory 710 to the internal memory 702, and execute the computer-executable instructions, thereby forming a navigation apparatus having the application interfaces at a logic level. Certainly, in addition to implementation by software, the present disclosure does not exclude other forms of implementations, such as a logic device or a combination of software and hardware. That is, the main entity for executing the processing flow is not restricted to logic units, and may be hardware or logic devices. The electronic device may also include one or more input and output interfaces (not shown in FIG. 7).

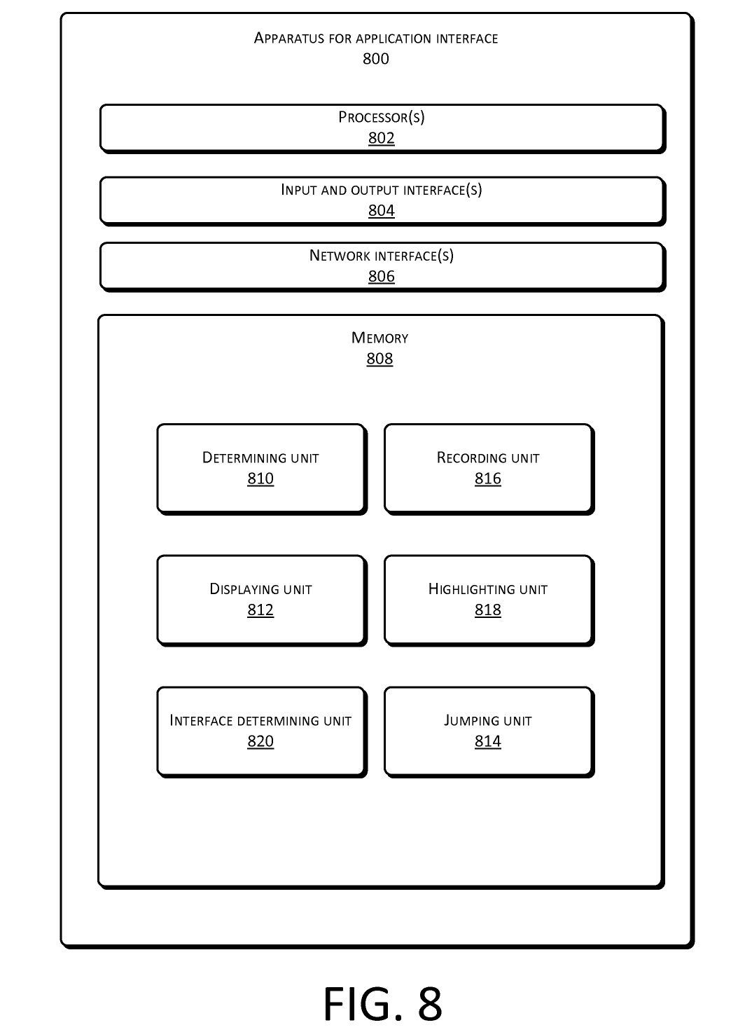

Referring to FIG. 8, an example navigation apparatus for application interfaces 800 may include one or more processor(s) 802 or data processing unit(s), input and output interface(s) 804, network interface(s) 806, and memory 808. The memory 808 is an example of computer-readable media.

The memory 808 may store therein a plurality of modules or units including a determining unit 810 and a displaying unit 812.

The determining unit 810 determines a current application interface on a terminal screen when detecting a preset trigger event.

The displaying unit 812 displays interface navigation information corresponding to an application to which the current application interface belongs, in which the interface navigation information includes a plurality of display elements in a hierarchical structure, and the hierarchical structure corresponds to a hierarchical relationship among a plurality of application interfaces of the application.

Optionally, the plurality of modules or units further include a jumping unit 814 that, when any one of the display elements in the interface navigation information is triggered, displays or jumps from the current application interface to an application interface corresponding to the triggered display element.

Optionally, the displaying unit 812 further calls pre-generated interface navigation information corresponding to the application, based on the application to which the current application interface belongs, in which the display elements in the interface navigation information correspond to all application interfaces of the application.

Optionally, the plurality of modules or units further include a recording unit 816 that records application interfaces browsed during a current-time operation of the application; and a highlighting unit 818 that highlights display elements corresponding to the browsed application interfaces in the interface navigation information.

Optionally, the displaying unit 812 further records browsed application interfaces during the current-time operation of application, generates the interface navigation information based on a hierarchical relationship among all of the browsed application interfaces.

Optionally, the plurality of modules or units further include an interface determining unit 820 that determines application interfaces having a hierarchical relationship with the current application interface among all of the browsed application interfaces.

The displaying unit 812 further generates the interface navigation information based on the determined application interfaces.

Optionally, the displaying unit 812 further determines application interfaces having a hierarchical relationship with the current application interface in the application and generates the interface navigation information based on the determined application interfaces.

Optionally, displaying effects of the display elements corresponding to the current application interface are different from that of the other display elements.

Therefore, by generating interface navigation information corresponding to a hierarchical relationship among the application interfaces, the present disclosure enables the user to conveniently finds a structural relationship among the application interfaces in the current application, and quickly locates and searches operations of the application interfaces, which is helpful for enhancing a manipulation efficiency of the applications.

In a standard configuration, a computing device, such as a terminal or a server, as described in the present disclosure may include one or more central processing units (CPU), one or more input/output interfaces, one or more network interfaces, and memory.

The memory may include forms such as non-permanent memory, random access memory (RAM), and/or non-volatile memory such as read only memory (ROM) and flash random access memory (flash RAM) in the computer-readable media. The memory is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

It should be noted that the term “including,” “comprising,” or any variation thereof refers to non-exclusive inclusion so that a process, method, product, or device that includes a plurality of elements does not only include the plurality of elements but also any other element that is not expressly listed, or any element that is essential or inherent for such process, method, product, or device. Without more restriction, the elements defined by the phrase “including a . . . ” does not exclude that the process, method, product, or device includes another same element in addition to the elements.

The above description describes the example embodiments of the present disclosure, which should not be used to limit the present disclosure. One of ordinary skill in the art may make any revisions or variations to the present techniques. Any change, equivalent replacement, or improvement without departing the spirit and scope of the present techniques shall still fall under the scope of the present disclosure.

What is claimed is:

1. A method comprising:
determining a current application interface on a terminal screen; and
displaying interface navigation information corresponding to an application to which the current application interface belongs, the interface navigation information including a plurality of display elements in a hierarchical structure, the hierarchical structure corresponding to a hierarchical relationship among a plurality of application interfaces of the application.

2. The method of claim 1, further comprising jumping from the current application interface to display an application interface corresponding to a respective display element of the plurality of display elements, in response to determining that the respective display element is triggered.

3. The method of claim 1, wherein the displaying the interface navigation information corresponding to the application to which the current application interface belongs includes calling pre-generated interface navigation information corresponding to the application.

4. The method of claim 1, wherein the displaying the interface navigation information corresponding to the application to which the current application interface belongs includes generating the interface navigation information in real time.

5. The method of claim 1, wherein the plurality of display elements in the interface navigation information correspond to multiple application interfaces of the application.

6. The method of claim 1, wherein the displaying the interface navigation information corresponding to the application to which the current application interface belongs includes recording browsed application interfaces during a current-time operation of the application.

7. The method of claim 6, further comprising highlighting display elements corresponding to the browsed application interfaces.

8. The method of claim 6, wherein the displaying the interface navigation information corresponding to the application to which the current application interface belongs further comprises generating the interface navigation information based on a hierarchical relationship among the browsed application interfaces.

9. The method of claim 6, wherein the displaying the interface navigation information corresponding to the application to which the current application interface belongs further comprises:
determining one or more application interfaces, within the browsed application interfaces, having a hierarchical relationship with the current application interface; and
generating the interface navigation information based on the determined one or more application interfaces.

10. The method of claim 1, wherein the displaying the interface navigation information corresponding to the application to which the current application interface belongs comprises:
determining one or more application interfaces having a hierarchical relationship with the current application interface in the application; and
generating the interface navigation information based on the determined one or more application interfaces.

11. The method of claim 1, further comprising rendering a displaying effect of a display element corresponding to the current application interface different from that of another display element corresponding to another application interface.

12. The method of claim 1, wherein the determining the current application interface on the terminal screen includes determining the current application interface on the terminal screen when detecting a preset triggering event.

13. An apparatus comprising:
a determining unit that determines a current application interface on a terminal screen; and
a displaying unit that displays interface navigation information corresponding to an application to which the current application interface belongs, the interface navigation information including a plurality of display elements in a hierarchical structure, the hierarchical structure corresponding to a hierarchical relationship among a plurality of application interfaces of the application, a respective display element in the interface navigation information correspond to a respective application interface of the application.

14. The apparatus of claim 13, further comprising a jumping unit that jumps from the current application interface to display a respective application interface corresponding to the respective display element of the plurality of display elements, in response to determining that the respective display element is triggered.

15. The apparatus of claim 13, wherein the displaying unit further calls pre-generated interface navigation information corresponding to the application.

16. The apparatus of claim 13, wherein the displaying unit further generates the interface navigation information in real time.

17. The apparatus of claim 13, further comprising a recording unit that records browsed application interfaces during a current-time operation of the application.

18. The apparatus of claim 13, wherein the displaying unit further generates the interface navigation information based on a hierarchical relationship among the browsed application interfaces.

19. The apparatus of claim 13, further comprising an interface determining unit that determines one or more application interfaces having a hierarchical relationship with the current application interface in the application,
wherein the displaying unit further generates the interface navigation information based on the determined one or more application interfaces.

20. One or more memories having stored thereon computer-executable instructions that are executable by one or more processors to perform operations comprising:
determining a current application interface on a terminal screen; and
displaying interface navigation information corresponding to an application to which the current application interface belongs, the interface navigation information including a plurality of display elements in a hierarchical structure, the hierarchical structure corresponding to a hierarchical relationship among a plurality of application interfaces of the application.
